(19) United States
(12) Patent Application Publication
(10) Pub. No.: US 2006/0140461 A1
(43) Pub. Date: Jun. 29, 2006

(54) Mobile communication device having fingerprint recognition sensor

(75) Inventors: Taek Soo Kim, Goyang-si (KR); Ho Won Kim, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/321,584

(22) Filed: Dec. 28, 2005

(30) Foreign Application Priority Data
Dec. 29, 2004 (KR) 10-2004-0115126

(51) Int. Cl. G06K 9/00

(52) U.S. Cl. 382/126

(57) ABSTRACT

There is provided a mobile communication device. The mobile communication device includes a housing, a fingerprint recognition sensor for inputting fingerprint data, a rotational unit rotatably coupled to a portion of the housing where a keypad is located, the fingerprint recognition sensor being mounted on a top surface of the fingerprint recognition sensor, and a process unit for performing a user identification process by analyzing the fingerprint data inputted from the fingerprint sensor using a fingerprint recognition algorithm.

Pursuant to 35 U.S.C. §119(a), this application claims the benefit of earlier filing date and right of priority to Korean Patent Application No(s). 10-2004-0115126 filed on Dec. 29, 2004, which is hereby incorporated by reference herein in their entirety.

### BACKGROUND OF THE INVENTION

1. Field of the Invention

The present invention relates to a mobile communication device having a fingerprint recognition sensor. 2. Description of the Related Art

Recently, a variety of mobile communication devices such as a mobile phone, a personal digital assistant, an i-Book phone, a smart phone, and the like have been popularized.

The mobile communication device provides a variety of functions such as a basic communication function, a mobile internet function, a digital organizing function, a cameral function, a game function, and the like. Particularly, as the mobile communication devices are widely used in a variety of fields, the mobile communication devices store personal information or secret information.

Therefore, the information security has been getting more important in using the mobile communication devices. In order to identify user's information, a password method has been used. However, in recent years, a variety of biometrics have been applied to the mobile communication devices.

Among the biometrics, a fingerprint recognition method has been widely applied to the mobile communication devices as an effective personal identification method since it can be realized by a simply structure and it has relatively high reliability.

A fingerprint recognition sensor is classified according to a type of a fingerprint recognition sensor into an optical type sensor, a thermal sensor, a semiconductor sensor type. Due to a space limitation of the mobile communication device, the semiconductor sensor type is generally used.

FIG. 1 is a view illustrating outer appearances of a space type fingerprint recognition sensor and a slide type fingerprint recognition sensor according to the related art and FIG. 2 is a view of an example where a slide type fingerprint recognition sensor is attached on a mobile communication device according to the related art.

As shown in FIG. 1, a semiconductor sensor is further classified into a space type sensor A and a slide type sensor B. The space type sensor A is designed to detect a surface of a finger at once and the slide type sensor B is designed to receive overall fingerprint data by sweeping a finger on a slot-shaped sensor surface.

FIG. 3 is a view illustrating a sweeping state of a finger on a slide type sensor when a user grasps a mobile communication device according to the related art.

Referring to FIGS. 2 and 3, in a mobile communication device, a variety of elements such as a key pad having buttons, an liquid crystal display (LCD) and the like are arranged in a limited space. Thus, the slide type sensor B for recognizing the fingerprint is generally applied to the mobile communication device. The fingerprint recognition sensor has been developed to function as a mouse as well as user identification means.

In the slide type fingerprint recognition sensor B, a fingerprint recognition result varies in accordance with a sweeping speed and direction. In order to guide a sweeping action, a guide member “a” is provided on both sides of the slide type fingerprint recognition sensor B.

An algorithm used for the prior slide type fingerprint recognition system B is generally premised on that a finger accurately sweeps the slot-shaped sensor surface in a vertical direction.

That is, the fingerprint may be erroneously recognized in accordance with the sweeping speed or direction. The sweeping action depends on a hand used, a kind of fingers used for grasping the mobile communication device, a user's habit, or a kind of finger operating the buttons.

However, as shown in FIG. 2, the prior mobile communication device is designed considering only a mechanical arrangement rather than a sweeping convenience. Therefore, the fingerprint recognition sensor is arranged with lockstep. As a result, when a user uses the fingerprint recognition sensor, the user may feel inconvenience in using the sensor and the recognition may be erroneously performed.

Particularly, when the fingerprint recognition sensor is used as the mouse, the finger must be placed on the fingerprint recognition sensor. However, due to the size limitation of the mobile communication device, the unnatural finger action on the mobile communication device may occur.

Furthermore, sine no click button is provided to the mobile communication device, the user who is used to a personal computer may feel inconvenience.

### SUMMARY OF THE INVENTION

Accordingly, the present invention is directed to a mobile communication device having a fingerprint recognition sensor that substantially obviates one or more problems due to limitations and disadvantages of the related art.

An object of the present invention is to provide a mobile communication device that has a fingerprint recognition sensor that is movable to make it convenient to perform a sweeping action and can precisely adjust a pointer location when the fingerprint recognition sensor is used as a mouse.

Another object of the present invention is to provide a mobile communication device having a fingerprint recognition sensor that has a click button formed close to the fingerprint recognition sensor so that a finger adjusting a movement of a pointer can be used for operating the click button.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a mobile communication device including: a housing; a fingerprint recognition sensor for inputting fingerprint data; a rotational unit rotatably coupled to a portion of the housing where a keypad is located, the fingerprint recognition sensor being mounted on a top surface of the fingerprint recognition sensor; and a process unit for performing a user identification process by analyzing the fingerprint data inputted from the fingerprint sensor using a fingerprint recognition algorithm.

In another aspect of the present invention, there is provided a mobile communication device including: a housing; a rotation guide unit formed on the housing; and a rotational unit for rotatably supporting a fingerprint recognition unit, the rotational unit being coupled to the rotation guide unit.

In still another aspect of the present invention, there is provided a mobile communication device including: a housing; a fingerprint input unit formed on the housing to input a fingerprint rotation guide unit formed on the housing; and a guide member formed on the housing to guide a sweeping of a finger, the guide member being inclined in a direction of a longitudinal axis.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating outer appearances of a space type fingerprint recognition sensor and a slide type fingerprint recognition sensor according to the related art;

FIG. 2 is a view of an example where a slide type fingerprint recognition sensor is associated with a mobile communication device according to the related art;

FIG. 3 is a view illustrating a sweeping action of a finger on a slide type sensor when a user grasps a mobile communication device according to the related art;

FIG. 4 is a block diagram of a mobile communication device having a fingerprint recognition sensor according to an embodiment of the present invention;

FIGS. 5 and 6 are respectively top perspective and side views of a rotational unit depicted in FIG. 4;

FIGS. 7 and 8 are partial views illustrating a snap coupling structure between a rotational disk and a circular rail that are depicted in FIGS. 5 and 6;

FIGS. 9 through 11 are views illustrating three rotating positions of a finger print recognition sensor of a mobile communication device according to an embodiment of the present invention;

FIG. 12 is a block diagram of a process unit depicted in FIG. 4; and

FIG. 13 is a view of an example of a mode selection screen of the fingerprint recognition sensor provided by a third user interface of a mobile communication device according to an embodiment of the present invention.

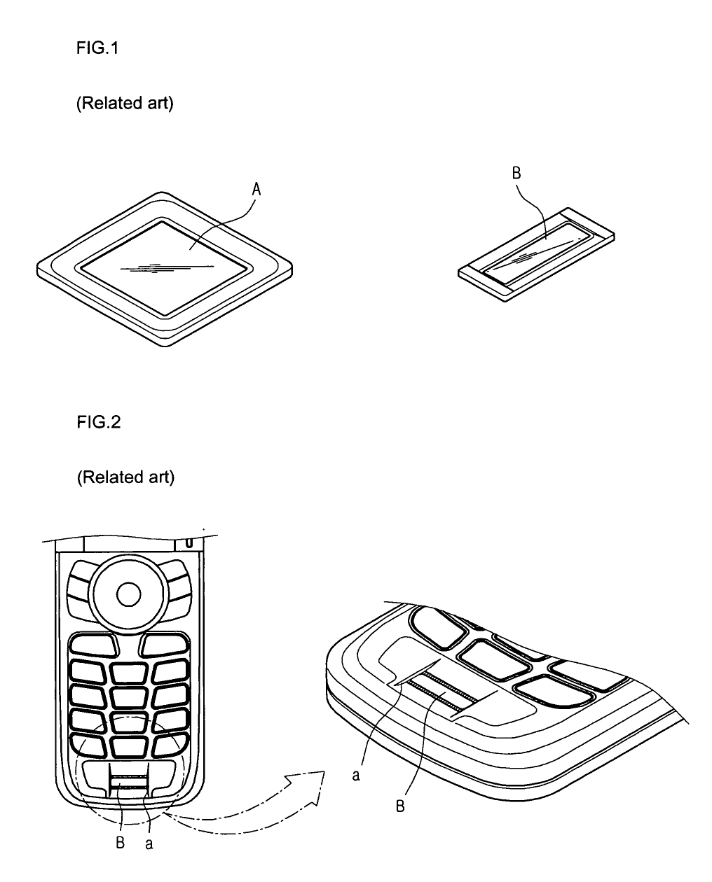

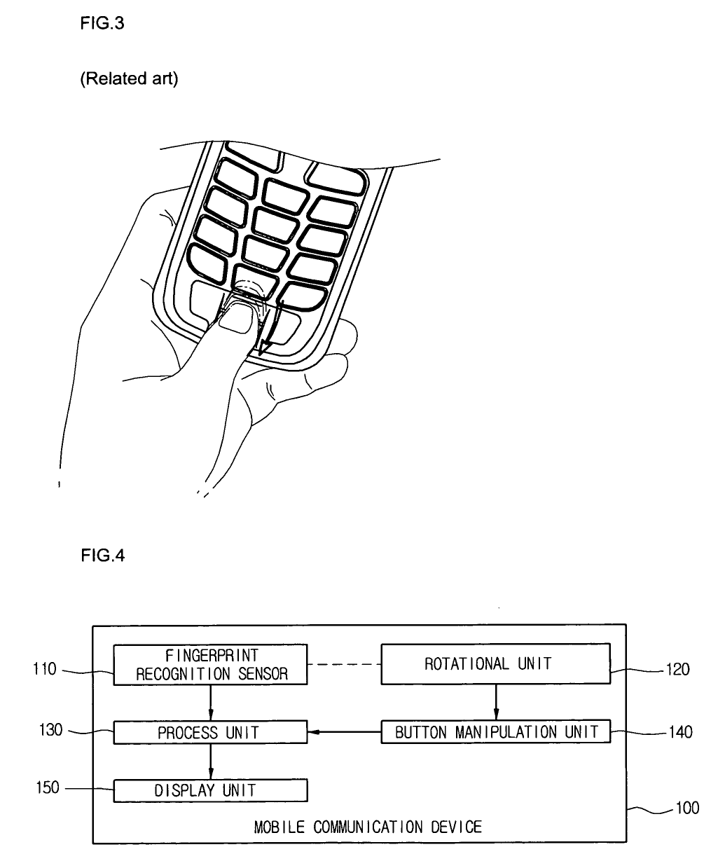

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

FIG. 4 is a block diagram of a mobile communication device having a fingerprint recognition sensor according to an embodiment of the present invention.

Referring to FIG. 4, the inventive mobile communication device includes a fingerprint recognition sensor 110, a rotational unit 120, a button manipulation unit 140, a display unit 150, and a process unit 130.

The fingerprint recognition sensor 110 is a slide type that can perform a fingerprint recognition by locally reading a fingerprint image by sweeping the sensor using a finger sweeping the sensor and recomposing the read information as an image or consecutively transmit local fingerprint data.

The fingerprint recognition sensor 110 is mounted on the rotational unit 120 that is rotatably coupled to a housing of the mobile communication device 100. Therefore, the fingerprint recognition sensor 110 can be rotated to a proper position according to user's manipulation habit.

A guide member may be formed on the rotational unit 110 around the fingerprint recognition sensor 110. The guide member may be formed in a button type so that it can be used as a click button to provide manipulation convenience, thereby reducing a manipulation error and an erroneous recognition. This will be now described in more detail with reference to FIGS. 5 through 8.

The button manipulation unit 140 includes a keypad having a variety of buttons and a driving chipset. The button manipulation unit 140 transmits a driving signal to the process unit 130 according to the manipulation of the buttons.

When the fingerprint data is transmitted from the fingerprint recognition sensor 110 to the process unit 130, the process unit 130 processes the fingerprint data to perform the user identification. The process unit 130 provides a mouse function according to a manipulation signal of the fingerprint recognition sensor 110 and the rotational unit 120.

Also, the process unit 130 calculates movement and event data of each object constituting a screen based on data transmitted from the button manipulation unit 140, the rotational unit 120 and the fingerprint recognition sensor 110 and transmits the calculated data to the display unit 150.

The process unit 130 will be now described in more detail with reference to FIG. 10.

The display unit 150 displays an image by receiving movement and invent data of the objects from the process unit 130.

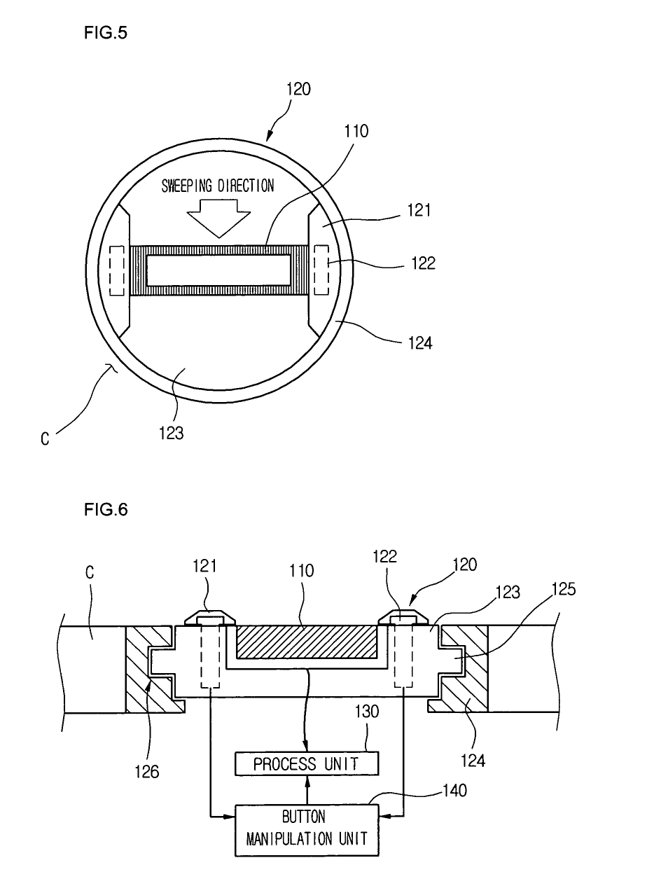

FIGS. 5 and 6 are respectively top perspective and side views of a rotational unit depicted in FIG. 4.

Referring first to FIG. 5, the rotational unit 120 includes a circular rail 124, a rotational disk 123 and a guide member 121. The circular rail 124 is ring-shaped and provided at an inner circumference with a sliding groove 126. The circular rail 124 is coupled to a circular opening formed on a top surface C (on which the keypad is mounted) of the housing of the mobile communication device.

The rotational disk 123 is inserted in the inner circumference of the circular rail 124. The fingerprint recognition senor 110 is attached on the top surface of the rotational disk 123. The rotational disk 123 is provided with a side surface that contacts the circular rail 124 with a hook portion 125 by which it can be rotatably coupled to the circular rail 124.

Also, the rotational disk 123 is provided with two guide members 121 for guiding a sweeping action of the finger. The guide members 121 abut opposite lateral side ends of the fingerprint recognition sensor 110. In order to form button portions 122 on respective bottoms of the guide members 121, the guide members 121 are arranged not to overlap portions coupled to the circular rail 124.

As shown in FIG. 6, the guide member 121 includes a cover portion 120 as well as the button portion 122. The button portion 122 is fixed on the rotational disk 123 and the cover portion 120 coupled to a press button of the button portion 122 to guide the finger or provide an easy press contact surface.

The button portion 122 is associated with the button manipulation unit 140 to transmit a switching signal.

Here, the cover portion 122 and the button portion 122 are movable in a vertical direction. However, the cover portion 120 is long in a horizontal direction to function as a guide rail and have a resistance against a predetermined pressure in the horizontal direction so as not to easily move. Therefore, the erroneous manipulation does not easily occur.

The button manipulation unit 140 processes the switching signal transmitted from the guide members 121 and transmits the processed switching signal to the process unit 130 to provide a predetermined button function.

By the above-described structure, the user can easily rotate the rotational disk 123 using his/her finger supported on the guide members 121. There is no need to fix a location of the rotational disk 123 rotated by a predetermined angle for the user's convenience.

Therefore, the rotational disk 123 and the circular rail 124 are correspondingly coupled to each other through a snap-coupling structure.

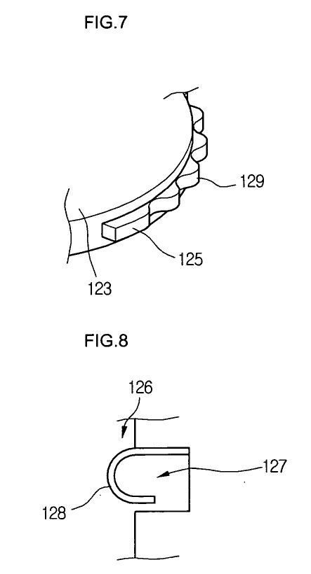

FIGS. 7 and 8 are partial views illustrating a snap coupling structure between a rotational disk and circular rail that are depicted in FIGS. 5 and 6.

Referring first to FIG. 7, a wave structure 129 is formed on a side surface of the hook portion 125 of the rotational disk 123. Referring to FIG. 8, a groove 127 is formed on a portion (that contacts the side surface of the hook portion 125) of the sliding groove 126 of the circular rail 124 and an elastic member 128 is fixedly inserted in the groove 127.

A portion (that contacts the wave portion 129) of the elastic member 128 is rounded to elastically move the rotational disk 123. The elastic member 128 is contracted into the groove 127 when it is vertically pressed.

Therefore, when a predetermined force is applied to the rotational disk 123, the rotational disk 123 is rotated by a predetermined angle and fixed on the circular rail 124.

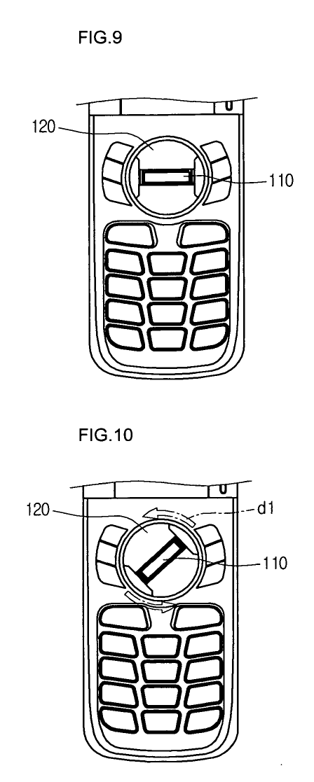

FIGS. 9 through 11 show three rotating positions of a finger print recognition sensor of a mobile communication device according to an embodiment of the present invention.

Referring to FIGS. 9 through 11, the rotational unit 120 is installed on an upper portion of a top surface of the housing to which the keypad is coupled. Therefore, the user can easily manipulate the rotational unit 120 using, for example, his/her thumb in a state where he/she grasps the mobile communication device 100.

In FIG. 9, the fingerprint recognition sensor 110 is horizontally positioned. In FIG. 10, the fingerprint recognition sensor 110 is rotated by a predetermined angle counterclockwise.

The position of the fingerprint recognition sensor 110 shown in FIG. 9 is the general position. The position of the fingerprint recognition sensor 110 shown in FIG. 10 is for a right-handed person. That is, when the right-handed person grasps the mobile communication device 100, his/her thumb moves in a direction where the fingerprint recognition sensor is positioned as shown in FIG. 10. Therefore, when the rotational unit 120 rotates together with the fingerprint recognition sensor 110 by the predetermined angle counterclockwise as indicated by arrow d1, it is easy to perform the sweeping action and to manipulate the guide members 121.

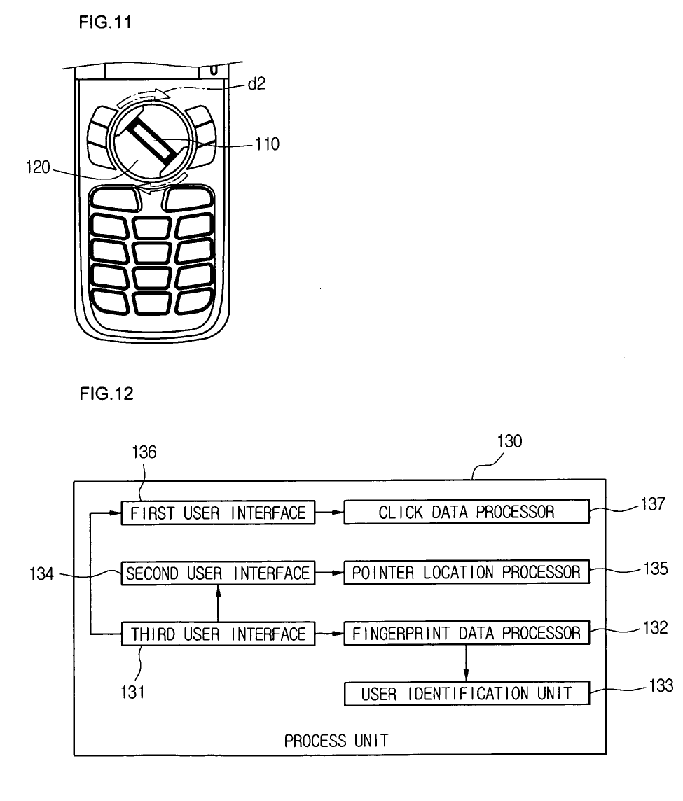

The position of the fingerprint recognition sensor 110 shown in FIG. 10 is for a left-handed person. That is, when the left-handed person grasps the mobile communication device 100, his/her thumb moves in a direction where the fingerprint recognition sensor is positioned as shown in FIG. 11. Therefore, when the rotational unit 120 rotates together with the fingerprint recognition sensor 110 by the predetermined angle clockwise as indicated by arrow d1, it is easy to perform the sweeping action and to manipulate the guide members 121.

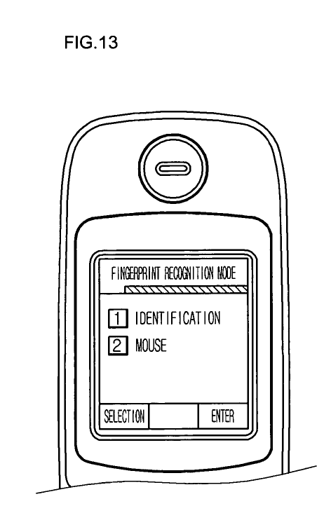

FIG. 12 is a block diagram of the process unit 130 depicted in FIG. 4.

Referring to FIG. 12, the process unit 130 includes a first user interface 136, a second user interface 134, a third user interface 131, a fingerprint data processor 132, a pointer position processor 135, a click data processor 137, and an identification unit 133.

The third user interface 131 functions as selection means for detecting if the fingerprint recognition sensor 110 is used as means for moving a mouse pointer or means for inputting fingerprint data. The third user interface 131 receives selection information from the user.

FIG. 13 is a view of an example of a mode selection screen of the fingerprint recognition sensor 110 provided by the third user interface 131 of the mobile communication device 100 according to an embodiment of the present invention.

The third user interface 131 drives the first and second user interfaces 136 and 134 or the fingerprint data processor 132 according to the selection information inputted by the user.

The fingerprint data processor 132 has a fingerprint recognition algorithm to process the fingerprint data inputted from the fingerprint recognition sensor 110. The fingerprint data may be recomposed as image data by integrating local fingerprint data according to the fingerprint recognition algorithm.

At this point, the fingerprint data processor 132 processes the fingerprint data using an image process algorithm such as an image segmentation method including a discontinuity detection, an edge connection and an threshold value calculation, a representation and boundary description method, and the like.

Next, the identification unit 133 compares a fingerprint pattern of the user that is registered in advance with an inputted fingerprint pattern to process the identification and activates information stored in the mobile communication device 100.

Meanwhile, when driving selection signal is transmitted from the third user interface 131 to the first user interface 136, the first user interface 131 cooperates with the button manipulation unit 140 to receive a click signal from the guide members 121 functioning as the click buttons.

The first user interface 136 has a program module for realizing functions identical to those of left and right click buttons of the mouse for the personal computer. The click data processor 137 is associated with other application programs including the click button program module to process the click data.

When the driving selection signal is transmitted from the third user interface 131 to the second user interface 134, the second user interface 134 is driven together with the first user interface 136.

When the finger placed on the fingerprint recognition sensor 110 minutely moves, the second user interface 134 generates movement information by calculating a shade difference between a series of data inputted from the fingerprint recognition sensor 110 and converts the movement information into pointer location information that is formatted to be applicable to the display unit 150 and usable for each application program provided in the mobile communication device 100.

According to the above-described mobile communication device with the fingerprint recognition device, since the fingerprint recognition sensor is designed to rotate according to the user's characteristics such as a general hand grasping the mobile communication device, a grasping habit, a button manipulation habit, and the like, the sweeping can be performed at a proper speed in a proper direction. Furthermore, when the fingerprint recognition sensor is used as the mouse, the manipulation of the sensor becomes easy.

In addition, since the guide members for guiding the sweeping action can be used as the click buttons, the user can conveniently performs the grasping of the mobile communication device, the movement of the pointer and the clicking by using only one hand.

Furthermore, since the recognition rate of the sensor is improved, the erroneous recognition can be reduced. In addition, user-friendly interface can be provided for the user who is used to the personal computer.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A mobile communication device comprising:
a housing;
a fingerprint recognition sensor for inputting fingerprint data;
a rotational unit rotatably coupled to a portion of the housing where a keypad is located, the fingerprint recognition sensor being mounted on a top surface of the fingerprint recognition sensor; and
a process unit for performing a user identification process by analyzing the fingerprint data inputted from the fingerprint sensor using a fingerprint recognition algorithm.

2. The mobile communication device according to claim 1, wherein the fingerprint recognition sensor is a slide type sensor where the fingerprint data are inputted by a sweeping action of the finger.

3. The mobile communication device according to claim 1, wherein the rotational unit comprises a guide member formed on both sides of the fingerprint recognition sensor.

4. The mobile communication device according to claim 3, wherein the guide member is formed in a press button structure to provide a switching function.

5. The mobile communication device according to claim 1, wherein the guide member performs a button operation in a vertical direction and is rail-shaped to be fixed in a horizontal direction, thereby having a resistance against a predetermined pressure in the horizontal direction.

6. The mobile communication device according to claim 3, wherein the process unit comprises a user interface for processing click data inputted from the guide member so that the guide member functions as left and right buttons of a mouse.

7. The mobile communication device according to claim 1, wherein the process unit comprises a user interface for generating location data of a mouse pointer by calculating a shade difference between a series of data inputted from the fingerprint recognition sensor to move the mouse pointer on a display unit.

8. The mobile communication device according to claim 7, wherein the process unit comprises selection means for detecting if the fingerprint recognition sensor 110 is used as means for moving a mouse pointer or means for inputting fingerprint data.

9. The mobile communication device according to claim 1, wherein the rotational unit comprises a circular rail coupled to a circular opening formed on the housing and a rotational disk coupled to the circular rail, the fingerprint recognition sensor being coupled to a top surface of the rotational disk.

10. The mobile communication device according to claim 9, wherein the rotational disk and the circular rail are correspondingly coupled to each other through a snap-coupling structure so that the rotational disk can be fixed after the rotational disk rotates by a predetermined rotational angle when outer force is applied to rotational disk.

11. A mobile communication device comprising:
a housing;
a rotation guide unit formed on the housing; and
a rotational unit for rotatably supporting a fingerprint recognition unit, the rotational unit being coupled to the rotation guide unit.

12. The mobile communication device according to claim 11, wherein the fingerprint recognition sensor is a slide type sensor where the fingerprint data are inputted by a sweeping action of the finger.

13. The mobile communication device according to claim 11, wherein the rotational unit comprises a guide member formed on both sides of the fingerprint recognition sensor.

14. The mobile communication device according to claim 13, wherein the guide member is formed in a press button structure to provide a switching function.

15. A mobile communication device comprising:
a housing;
a fingerprint input unit formed on the housing to input a fingerprint rotation guide unit formed on the housing; and
a guide member formed on the housing to guide a sweeping of a finger, the guide member being inclined in a direction of a longitudinal axis.

16. The mobile communication device according to claim 15, wherein the fingerprint input unit and the guide member rotate relative to the housing.

17. The mobile communication device according to claim 15, wherein the guide member functions as a switch.
